(19) United States
(12) Patent Application Publication
(10) Pub. No.: US 2025/0077852 A1
(43) Pub. Date: Mar. 6, 2025

(54) SPIKING NEURON REINFORCING CIRCUIT AND REINFORCING METHOD

(71) Applicants: BEIJING MICROELECTRONICS TECHNOLOGY INSTITUTE, Beijing (CN); BEIJING MXTRONICS TECHNOLOGY CO., LTD, Beijing (CN)

(72) Inventors: Hui QIN, Beijing (CN); Lei CHEN, Beijing (CN); Yanlong ZHANG, Beijing (CN); Liang WANG, Beijing (CN); Liguo SONG, Beijing (CN); Miao CHEN, Beijing (CN); Hongchao ZHENG, Beijing (CN); Tongde LI, Beijing (CN); Lei ZHU, Beijing (CN); Yuanfu ZHAO, Beijing (CN)

(21) Appl. No.: 18/723,914

(22) PCT Filed: Jul. 12, 2022
(86) PCT No.: PCT/CN2022/105098

§ 371 Date: Jun. 25, 2024

(30) Foreign Application Priority Data
Dec. 29, 2021 (CN) 202111681671.5

(51) Int. Cl. G06N 3/063; G06N 3/049

(52) U.S. Cl. CPC G06N 3/063; G06N 3/049

(57) ABSTRACT

A spiking neuron reinforcing circuit and a spiking neuron reinforcing method are provided.

### CROSS-REFERENCE TO RELATED APPLICATION

This application is the U.S. national phase of PCT Application No. PCT/CN2022/105098, filed on Jul. 12, 2022, which claims priority to the Chinese patent application No. 202111681671.5 with a title “SPIKING NEURON REINFORCING CIRCUIT AND REINFORCING METHOD”, filed on Dec. 29, 2021, the entire contents of both of which are incorporated herein by reference.

### FIELD

The present disclosure relates to a spiking neuron reinforcing circuit and a spiking neuron reinforcing method, and relates to the field of the spiking neural network technology.

### BACKGROUND

The spiking neural network, as the third-generation neural network, is widely used in the field of Brain-inspired Neuromorphic Computing due to its biomimetic neurodynamic characteristic and event-driven advantage. A spiking neuron is a basic computing unit of the spiking neural network which achieves information transmission between neurons by integrated computation of an input spiking signal and outputting a new spiking signal to a subsequent neuron, in an operation mode of simulating a biological neuron. The spiking neuron outputs an exciting or inhibiting spiking signal by neuron firing through computing a model parameter of the neuron. The commonly used spiking neuron model includes a Leaky-Integrate-and-Fire (LIF) model proposed by Lapicque in 1907, an Izhikevich model proposed by E M. Izhikevich in 2003, and a Hodgkin-Huxley model proposed by Hodgkin and Huxley in 1952, among which the Izhikevich model is capable of simulating the most prominent 20 exciting or inhibiting spiking signals by neuron firing in the biological neuron.

The spiking neuron is highly susceptible to the negative influence of a single event effect in spatial applications. If a 1-bit error or multiple-bit error is present in the model parameter of the neuron due to single event upset or single event transient, an abnormal neuron firing behavior will occur, outputting an incorrect spiking signal, which will result in an incorrect output result from a Brain-inspired Neuromorphic Computing chip in a severe case.

### SUMMARY

The present disclosure aims to solve a technical problem to overcome shortcomings in the related art. For this, the present disclosure provides in embodiments a spiking neuron reinforcing circuit and a spiking neuron reinforcing method, solving the defect in the related art that a spiking neuron is prone to a computing error due to susceptibility to the influence of the single event effect, and thus effectively improving the spatial environment adaptability of the spiking neuron.

According to embodiments of the present disclosure, the spiking neuron reinforcing method includes: determining a type of a spiking neuron according to the configuration information and generating a spiking signal by neuron firing according to the model parameter, where the spiking neuron and the spiking signal by neuron firing are required for the spiking neural network; coding/decoding the configuration information and the model parameter by coding/decoding modules in an error checking and correcting mode, thus achieving error tolerance; and storing the configuration information and the model parameter in a shadow memory (or a third register group) as backup data and replacing an uncoded data corresponding to an error-checked data with the backup data, thereby achieving error tolerance.

The object of the present disclosure is achieved by the following technical solutions.

The present disclosure provides in embodiments a spiking neuron reinforcing circuit, including a coding module, configured to code one or both of a first data and a second data input externally or from a logic module;

a first register group, configured to store a coded first data;

a second register group, configured to store a coded second data;

a third register group, configured to directly store one or both of the first data and the second data;

a decoding module, configured to
decode one or both of the coded first data and the coded second data in an error checking and correcting (ECC) mode; and
recode a decoding result,
where a decoding mode of the decoding module corresponds to a coding mode of the coding module;

the logic module, configured to, based on the decoding result,
select one or both of a decoded first data and a decoded second data as an input for a configurable spiking neuronal computing unit, or
select one or both of the first data and the second data in the third register group as the input for both the configurable spiking neuronal computing unit and the coding module;

the configurable spiking neuronal computing unit, capable of being configured according to one or both of an input first data and an input second data.

According to an embodiment of the disclosure, the first data is configuration information, and the second data is a model parameter.

According to an embodiment of the disclosure, the configurable spiking neuronal computing unit is configured to be a Leaky-Integrate-and-Fire (LIF) neuron, an Izhikevich neuron, or a Hodgkin-Huxley neuron according to the configuration information.

According to an embodiment of the disclosure, the configurable spiking neuronal computing unit is configured to generate a corresponding exciting or inhibiting spiking signal by neuron firing according to the model parameter.

According to an embodiment of the disclosure, the third register group is spatially isolated from the first register group and the second register group, or the third register group is independently reinforced, for reducing a spatial single event effect.

According to an embodiment of the disclosure, the third register group is spatially isolated from the first register group and the second register group in a criss-cross layout, and

a first spatial distance between the third register group and the first register group, as well as a second spatial distance between the third register group and the second register group, are determined in accordance with spatial environment where the configurable spiking neuronal computing unit operates, and the spatial environment includes a space orbital altitude, a spatial irradiation environment, and a spatial layout for the first register group, the second register group and the third register group.

According to an embodiment of the disclosure, the coding module is configured to code one or both of the first data and the second data in an ECC mode.

According to an embodiment of the disclosure, the decoding module is configured to decode an input data in the error checking and correcting mode, for error checking and 1-bit error correcting.

According to an embodiment of the disclosure, in response to the decoding result of positive multiple-bit error checking, the logic module is configured to select the first data and the second data in the third register group as the input for both the configurable spiking neuronal computing unit and the coding module.

According to an embodiment of the disclosure, the coding module includes a first coding module and a second coding module, the first coding module is configured to code the first data input externally or from the logic module, and the second coding module is configured to code the second data input externally or from the logic module.

According to an embodiment of the disclosure, the decoding module includes a first decoding module and a second decoding module, the first decoding module is configured to decode the first data input externally or from the logic module in the error checking and correcting mode, and the second decoding module is configured to decode the second data input externally or from the logic module in the error checking and correcting mode.

According to an embodiment of the disclosure, the coding mode of the coding module and the decoding mode of the decoding module codes/decodes an input data by different coding/decoding bits depending on different neuron models, for error checking and multiple-bit error correcting.

The present disclosure provides in embodiments a spiking neuron reinforcing method, including

performing raw storage on one or both of a first data and a second data input externally;

coding one or both of the first data and the second data input externally;

storing a coded first data and a coded second data separately;

decoding one or both of the coded first data and the coded second data in an error checking and correcting (ECC) mode;

in response to fewer errors present during decoding, selecting an error-corrected data for configuring a spiking neuron; or

in response to more errors present during decoding, selecting one or both of the first data and the second data in the raw storage for configuring the spiking neuron and replacing an uncoded data corresponding to the error-checked data.

According to an embodiment of the disclosure, the first data is configuration information, according to which the spiking neuron is configured to be a Leaky-Integrate-and-Fire (LIF) neuron, an Izhikevich neuron, or a Hodgkin-Huxley neuron.

According to an embodiment of the disclosure, the second data is a model parameter, according to which the spiking neuron is configured to generate a corresponding exciting or inhibiting spiking signal by neuron firing.

According to an embodiment of the disclosure, the raw storage is spatially isolated from coded data storage, or the raw storage is independently reinforced, for reducing a spatial single event effect.

According to an embodiment of the disclosure, the raw storage is spatially isolated from the coded data storage in a criss-cross layout with a spatial isolation distance determined in accordance with spatial environment where the spiking neuron operates, and the spatial environment includes a space orbital altitude, a spatial irradiation environment, and a spatial isolation layout.

According to an embodiment of the disclosure, the spiking neuron reinforcing method includes:

coding one or both of the first data and the second data in an ECC mode; and

decoding one or both of the coded first data and the coded second data in an ECC mode.

According to an embodiment of the disclosure, the spiking neuron reinforcing method includes decoding an input data in the error checking and correcting mode, for error checking and 1-bit error correcting.

According to an embodiment of the disclosure, the spiking neuron reinforcing method includes selecting one or both of the first data and the second data in the raw storage for configuring the spiking neuron in response to positive multiple-bit error checking during decoding.

According to an embodiment of the disclosure, the coding mode of the coding module matches with the decoding mode of the decoding module; and

an input data is coded/decoded by different coding/decoding bits depending on different neuron models, for error checking and multiple-bit error correcting.

According to an embodiment of the disclosure, the spiking neuron reinforcing method includes:

coding the first data by a first coding circuit; and

coding the second data by a second coding circuit.

According to an embodiment of the disclosure, the spiking neuron reinforcing method includes:

decoding the first data by a first decoding circuit in the error checking and correcting mode; and

decoding the second data by a second decoding circuit in the error checking and correcting mode.

According to embodiments of the present disclosure, the spiking neuron reinforcing circuit and the spiking neuron reinforcing method have the following beneficial effects compared to the related art.

(1) According to embodiments of the present disclosure, the spiking neuron may be configured to be various types of the neuron according to the configuration information, and to generate the respective spiking signals by neuron firing according to the model parameter corresponding to the type of the neuron configured, thus improving adaptability of the spiking neural network; and the spiking neuron may be configured to be another type of the neuron if the data of the configured neuron is damaged due to the single event effect caused by a spatial particle, thus improving reliability of the neuron.

(2) According to embodiments of the present disclosure, the data of the configuration information for the neuron, if with the single-bit error or the multiple-bit error presented, is automatically corrected by means of the error checking and correcting (ECC) mechanism, thus improving reliability of the neuron.

(3) According to embodiments of the present disclosure, in response to the multiple-bit error being checked in the data of the configuration information for the neuron, the arbitration correction control logic module controls the shadow memory (or the third register group) to output the backup correct data of the configuration information, and corrects the error-checked data of the configuration information, thus improving reliability of the neuron.

(4) According to embodiments of the present disclosure, the data of the model parameter for the neuron, if with the 1-bit error or the multiple-bit error presented, is automatically corrected by means of the error checking and correcting (ECC) mechanism, thus improving reliability of the neuron.

(5) According to embodiments of the present disclosure, in response to the multiple-bit error being checked in the data of the model parameter for the neuron, the arbitration correction control logic module controls the shadow memory (or the third register group) to output the backup correct data of the model parameter, and corrects the error-checked model parameter, thus improving reliability of the neuron.

### BRIEF DESCRIPTION OF THE DRAWINGS

FIG. 1 is a schematic diagram showing a highly reliable spiking neuron reinforcing circuit in an embodiment of the present disclosure;

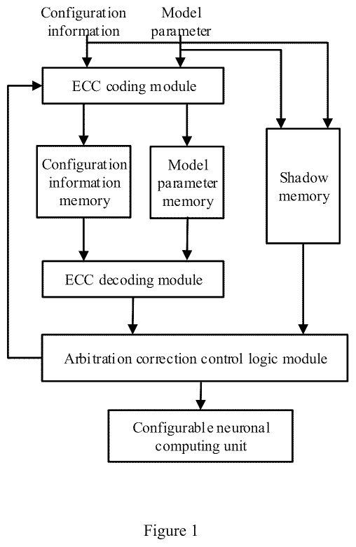

FIG. 2 is a logic flow chart showing a spiking neuron reinforcing method by an arbitration correction control logic module in an embodiment of the present disclosure.

### DETAILED DESCRIPTION

In order to make the objects, the technical solutions and advantages of the present disclosure clearer, the embodiments of the present disclosure will be further described in detail below in conjunction with the drawings.

### EXAMPLE 1

Provided are a spiking neuron reinforcing circuit and a spiking neuron reinforcing method. The spiking neuron reinforcing circuit includes an ECC coding module, a configuration information memory (or a first register group), a model parameter memory (or a second register group), an ECC decoding module, a configurable neuronal computing unit, a shadow memory (or a third register group), an arbitration correction control logic module.

The ECC coding module is composed of a first logic circuit for coding in an error checking and correcting mode; and is configured to code an input data for error checking and 1-bit error correcting.

The configuration information memory (or the first register group) is configured to store configuration information of various neuron models, according to which the configurable neuronal computing unit is configured to be a required spiking neuron such as a Leaky-Integrate-and-Fire (LIF) neuron, an Izhikevich neuron, or a Hodgkin-Huxley neuron.

The model parameter memory (or the second register group) is configured to store parameter information corresponding to the various neuron models, according to which the configurable neuronal computing unit is configured to generate a corresponding exciting or inhibiting spiking signal by neuron firing. For example, 20 sets of Izhikevich model parameters stored correspond to 20 types of neuron firing behaviors including tonic spiking, class 1 exciting and the like, respectively.

The ECC decoding module is composed of a second logic circuit for decoding in the error checking and correcting mode; and is configured to: decode an input data for error checking and 1-bit error correcting, output a correct result to the arbitration correction control logic module, in response to negative error checking or positive 1-bit error checking, and output an incorrect result to the arbitration correction control logic module, in response to positive multiple-bit error checking.

The configurable neuronal computing unit is composed of a configurable digital logic circuit (such as an adder, a multiplier and the like), or a configurable novel device (such as a memristor and the like); and is capable of being configured to be a corresponding spiking neuron according to the configuration information.

The shadow memory (or the third register group) is configured to store respective backups of the configuration information and the model parameter of the spiking neuron.

The arbitration correction control logic module is configured to, in response to the incorrect result output from the ECC decoding module, control the shadow memory (or the third register group) to output a backup correct data to both the configurable neuronal computing unit and the ECC coding module, thereby achieving correction of the checked error present in the configuration information memory and the model parameter memory.

Preferably, the highly reliable spiking neuron reinforcing method includes: coding the input data of the configuration information by the ECC coding module in the error checking and correcting mode; transmitting the coded data of the configuration information to the configuration information memory (or the first register group); correcting, by the ECC decoding module decoding in the error checking and correcting mode, the 1-bit error present in the data of the configuration information output from the configuration information memory (or the first register group) to the ECC decoding module; and selecting the decoded correct data of the configuration information as the input for the configurable neuronal computing unit.

Preferably, the highly reliable spiking neuron reinforcing method includes: coding the input data of the configuration information by the ECC coding module in the error checking and correcting mode; transmitting the coded data of the configuration information to the configuration information memory (or the first register group); and outputting, by the ECC decoding module decoding in the error checking and correcting mode, the incorrect result for the configuration information to the arbitration correction control logic module, in response to the multiple-bit error present in the data of the configuration information output from the configuration information memory (or the first register group).

Preferably, in the highly reliable spiking neuron reinforcing circuit, the arbitration correction control logic module is configured to, in response to receiving the incorrect result for the configuration information, control the shadow memory (or the third register group) to output the backup correct data of the configuration information to both the configurable neuronal computing unit and the ECC coding module. The ECC coding module is further configured to code the backup correct data of the configuration information in the error checking and correcting mode again, and output a correct coded data to the configuration information memory, thereby achieving correction of the checked error in the configuration information memory.

Preferably, the highly reliable spiking neuron reinforcing method includes: coding the input data of the model parameter by the ECC coding module in the error checking and correcting mode; transmitting the coded data of the model parameter to the model parameter memory (or the second register group); correcting, by the ECC decoding module decoding in the error checking and correcting mode, the 1-bit error present in the data of the model parameter output from the model parameter memory (or the second register group) to the ECC decoding module; and selecting the decoded correct data of the model parameter as the input for the configurable neuronal computing unit.

Preferably, the highly reliable spiking neuron reinforcing method includes: coding the input data of the model parameter by the ECC coding module in the error checking and correcting mode; transmitting the coded data of the model parameter to the model parameter memory (or the second register group); and outputting, by the ECC decoding module decoding in the error checking and correcting mode, the incorrect result for the model parameter to the arbitration correction control logic module, in response to the multiple-bit error present in the data of the model parameter output from the model parameter memory (or the second register group).

Preferably, in the highly reliable spiking neuron reinforcing circuit, the arbitration correction control logic module is configured to, in response to receiving the incorrect result for the model parameter, control the shadow memory (or the third register group) to output the backup correct data of the model parameter to both the configurable neuronal computing unit and the ECC coding module. The ECC coding module is further configured to code the backup correct data of the model parameter in the error checking and correcting mode again, and output a correct coded data to the model parameter memory, thereby achieving correction of the checked error in the model parameter memory.

Preferably, the shadow memory is arranged in a criss-cross layout with the configuration information memory and the model parameter memory in physical implementation, that is, the shadow memory is arranged to be spatially isolated from the configuration information memory and the model parameter memory with respective distances not less than a preset value in a range of 2 to 10 μm, thus enabling the spiking neuron reinforcing circuit to operate in a highly reliable manner under an entire orbital range across the Low Earth Orbit (LEO), the Middle Earth Orbit (MEO), the Geostationary Orbit (GEO), and the like.

More specifically, the following layout conditions are determined by the heavy particle Monte Carlo model simulation and comparative analysis with National Aeronautics and Space Administration (NASA) data and irradiation test data.

1) the respective distances between every two memories are not less than a first preset value in a range of 8 to 10 μm, in the case of a threshold value of the single event upset exceeding 37 MeV·cm²/mg or operation in the Middle Earth Orbit (MEO).

2) the respective distances between every two memories are not less than a second preset value in a range of 5 to 7 μm, in the case of the threshold value of the single event upset exceeding 15 MeV·cm2/mg or operation in the Geostationary Orbit (GEO).

3) the respective distances between every two memories are not less than a third preset value in a range of 2 to 4 μm, in the case of an error rate of the single event upset not greater than 1E-10/device·day or operation in the Low Earth Orbit (LEO).

### EXAMPLE 2

Provided are a spiking neuron reinforcing circuit and a spiking neuron reinforcing method. The spiking neuron reinforcing circuit may specifically include an ECC coding module, a configuration information memory, a model parameter memory, an ECC decoding module, a configurable neuronal computing unit, a shadow memory, and an arbitration correction control logic module.

An output end of the ECC coding module is connected to both the configuration information memory and the model parameter memory.

An output end of the configuration information memory and an output end of the model parameter memory each are connected to the ECC decoding module.

An output end of the ECC decoding module and an output end of the shadow memory each are connected to the arbitration correction control logic module.

An output end of the arbitration correction control logic module is connected to both the configurable neuronal computing unit and the ECC coding module.

In examples of the present disclosure, for the consideration of reducing power consumption and saving resources, the spiking neuron reinforcing circuit may include only one set of the ECC coding/decoding module, for coding/decoding the configuration information and the model parameter in the error checking and correcting mode by a time-division multiplexing module of a gating switch; alternatively may include two sets of the ECC coding/decoding modules (with one set corresponding to the configuration information memory and another set corresponding to the model parameter memory), for coding/decoding the configuration information and the model parameter in the error checking and correcting mode, separately.

In examples of the present disclosure, the configuration information memory is configured to store configuration information of various neuron models, according to which the configurable neuronal computing unit is configured to be a required spiking neuron in a neuron operating state, where the required spiking neuron may be the LIF neuron, the Izhikevich neuron, or the Hodgkin-Huxley neuron, and the neuron operating state may be a leaky mode, a threshold firing mode, or a reset mode.

In examples of the present disclosure, the model parameter memory is configured to store parameter information corresponding to the various neuron models, according to which the configurable neuronal computing unit is configured to generate a corresponding exciting or inhibiting spiking signal by neuron firing. For example, 20 sets of Izhikevich model parameters stored correspond to 20 types of neuron firing behaviors including tonic spiking, class 1 exciting and the like; 6 sets of Hodgkin-Huxley model parameters stored correspond to 6 types of exciting or inhibiting neuron firing behaviors including Regular Spiking (RS) by neuron firing, Intrinsic Bursting (IB) by neuron firing, Fast Spiking (FS) by neuron firing, and the like; and 3 sets of LIF model parameters stored correspond to 3 types of neuron firing behaviors including integrator firing and the like.

In a first implementation of the example of the present disclosure, the ECC coding module is composed of a first logic circuit for coding in the error checking and correcting mode, and is configured to code an input data for error checking and 1-bit error correcting, specifically with a Hamming code. The ECC decoding module is composed of a second logic circuit for decoding in the error checking and correcting mode; and is configured to decode an input data for error checking and 1-bit error correcting, specifically with the Hamming code; output a correct result (i.e., an error identifier being 0) to the arbitration correction control logic module, in response to negative error checking or positive 1-bit error checking; and output an incorrect result (i.e., an error identifier being 1) to the arbitration correction control logic module, in response to positive multiple-bit error checking.

In a second implementation of the example of the present disclosure, the ECC coding/decoding modules code/decode with a corresponding reinforcing strategy in line with complexity of the neuron model input.

a. With a simple neuron model, such as the LIF neuron model supporting 3 types of neuron firing behaviors, the configuration information and the model parameter (when a total length summing respective lengths not greater than 39 bits) are coded in a 4-bit correcting and 4-bit checking mode, which requires 24 verification bits, thus resulting in a code-length overhead of 63 bits (corresponding to 39 data bits plus 24 verification bits).

b. With a moderately complex neuron model, such as the Hodgkin-Huxley neuron model supporting 6 types of neuron firing behaviors, the configuration information and the model parameter (when a total length summing respective lengths not greater than 64 bits) are divided into 4 groups with 16 bits in each group coded in a 1-bit correcting and 2-bit checking mode, where 6 verification bits are required for each group, such that the configuration information and the model parameter are coded in a 4-bit correcting and 8-bit checking mode, resulting in a code-length overhead of 88 bits (corresponding to 64 data bits plus 24 verification bits).

c. With a complex neuron model, such as the Izhikevich neuron model supporting 20 types of neuron firing behaviors, the configuration information and the model parameter (when a total length summing respective lengths greater than 64 bits) are divided by 32 bits, with each group coded in a 1-bit correcting and 2-bit checking mode, where 7 verification bits are required for each group, thus achieving correction of multiple-bit error. For example, a 128-bit neuron data is divided into 4 groups with 32 bits in each group coded in the 1-bit correcting and 2-bit checking mode, where 7 verification bits are required for each group, such that the configuration information and the model parameter are coded in a 4-bit correcting and 8-bit checking mode, resulting in a code-length overhead of 156bits (corresponding to 128 data bits plus 28 verification bits).

In the case of coding/decoding with the above reinforcing strategy in the second implementation, in response to negative error checking or positive error checking with up to 4 bits which have been corrected, a correct result (i.e., the error identifier being 0) is output to the arbitration correction control logic module; otherwise, an incorrect result (i.e., the error identifier being 1) is output to the arbitration correction control logic module.

In an example of the present disclosure, the configurable neuronal computing unit is configured to be a corresponding spiking neuron according to the configuration information, and the configurable neuronal computing unit may specifically be configured to be the LIF neuron, the Izhikevichn neuron, or the Hodgkin-Huxley neuron achievable by a configurable digital logic circuit, like an adder, a multiplier and the like, or by a novel device like a memristor and the like.

In an example of the present disclosure, the shadow memory is configured to store respective backups of the configuration information and the model parameter of the spiking neuron. The arbitration correction control logic module is configured to, in response to the incorrect result output from the ECC decoding module, control the shadow memory to output a backup correct data to both the configurable neuronal computing unit, and the ECC coding module, for correcting the checked-error present in the configuration information memory and the model parameter memory.

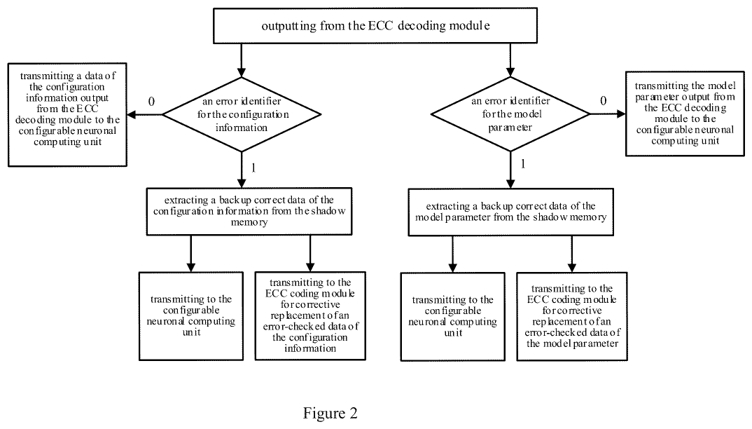

FIG. 2 is a logic flow chart showing a spiking neuron reinforcing method by an arbitration correction control logic module in an embodiment of the present disclosure.

The arbitration correction control logic module is configured to select a data of the configuration information output from the ECC decoding module for the configurable neuronal computing unit, in response to the error identifier for the configuration information output from the ECC decoding module being 0 (i.e., indicating that the data of the configuration information is correct); and extract and transmit the backup correct data of the configuration information from the shadow memory to both the configurable neuronal computing unit, and the ECC coding module, for corrective replacement of the error-checked data of the configuration information, in response to the error identifier for the configuration information output from the ECC decoding module being 1 (i.e., indicating that the data of the configuration information is incorrect).

The arbitration correction control logic module is also configured to select a data of the model parameter output from the ECC decoding module for the configurable neuronal computing unit, in response to the error identifier for the model parameter output from the ECC decoding module being 0 (i.e., indicating that the data of the model parameter is correct); and extract and transmit the backup correct data of the model parameter from the shadow memory to both the configurable neuronal computing unit, and the ECC coding module, for corrective replacement of the error-checked data of the model parameter, in response to the error identifier for the model parameter output from the ECC decoding module being 1 (i.e., indicating that the data of the model parameter is incorrect).

In an example of the present disclosure, the shadow memory is arranged in a criss-cross layout with the configuration information memory and the model parameter memory in physical implementation, that is, the shadow memory is arranged to be spatially isolated from the configuration information memory and the model parameter memory with respective distances not less than a preset value in a range of 2 to 10 μm, thus enabling the spiking neuron reinforcing circuit to operate in a highly reliable manner under an entire orbital range across the Low Earth Orbit (LEO), the Middle Earth Orbit (MEO), the Geostationary Orbit (GEO), and the like. Preferably, the shadow memory, the configuration information memory, and the model parameter memory are arranged in such a criss-cross layout that (1) every two of the three memories are mutually perpendicular; (2) the configuration information memory is parallel to the model parameter memory, and the shadow memory is perpendicular to both the configuration information memory and the model parameter memory; and (3) the configuration information memory is parallel to the model parameter memory, and the shadow memory is at an included angle greater than 60° to each of the configuration information memory and model parameter memory. For each layout, for ease of describing relationships between the three, each memory is understood to be of a sheet structure.

In the case of the spatial layouts (2) and (3), more specifically, the following layout conditions are determined by the heavy particle Monte Carlo model simulation and comparative analysis with NASA data and irradiation test data.

1) the respective distances between every two memories are not less than a first preset value in a range of 8 to 10 μm, in the case of a threshold value of the single event upset exceeding 37 MeV·cm²/mg or operation in the Middle Earth Orbit (MEO).

2) the respective distances between every two memories are not less than a second preset value in a range of 5 to 7 μm, in the case of the threshold value of the single event upset exceeding 15MeV·cm²/mg or operation in the Geostationary Orbit (GEO).

3) the respective distances between every two memories are not less than a third preset value in a range of 2 to 4 μm, in the case of an error rate of the single event upset not greater than 1E-10/device·day or operation in the Low Earth Orbit (LEO).

### Example 3

Provided is a spiking neuron reinforcing circuit, including

a coding module, configured to code one or both of a first data and a second data input externally or from a logic module;

a first register group, configured to store a coded first data;

a second register group, configured to store a coded second data;

a third register group, configured to directly store one or both of the first data and the second data;

a decoding module, configured to
decode one or both of the coded first data and the coded second data in an error checking and correcting (ECC) mode; and
recode a decoding result,
where a decoding mode of the decoding module corresponds to a coding mode of the coding module;

the logic module, configured to, based on the decoding result,
select one or both of a decoded first data and a decoded second data as an input for a configurable spiking neuronal computing unit, or
select one or both of the first data and the second data in the third register group as the input for both the configurable spiking neuronal computing unit and the coding module;

the configurable spiking neuronal computing unit, capable of being configured according to one or both of an input first data and an input second data.

In an example of the present disclosure, the first data is configuration information, and the second data is a model parameter.

In an example of the present disclosure, the configurable spiking neuronal computing unit is configured to be a Leaky-Integrate-and-Fire (LIF) neuron, an Izhikevich neuron, or a Hodgkin-Huxley neuron according to the configuration information.

In an example of the present disclosure, the configurable spiking neuronal computing unit is configured to generate a corresponding exciting or inhibiting spiking signal by neuron firing according to the model parameter.

In an example of the present disclosure, the third register group is spatially isolated from the first register group and the second register group, or the third register group is independently reinforced, for reducing a spatial single event effect.

In an example of the present disclosure, the third register group is spatially isolated from the first register group and the second register group in a criss-cross layout, and

a first spatial distance between the third register group and the first register group, as well as a second spatial distance between the third register group and the second register group, are determined in accordance with spatial environment where the configurable spiking neuronal computing unit operates, and the spatial environment includes a space orbital altitude, a spatial irradiation environment, and a spatial layout for the first register group, the second register group and the third register group.

In an example of the present disclosure, the coding module is configured to code one or both of the first data and the second data in an ECC mode.

In an example of the present disclosure, the decoding module is configured to decode an input data in the error checking and correcting mode, for error checking and 1-bit error correcting.

In an example of the present disclosure, in response to the decoding result of positive multiple-bit error checking, the logic module is configured to select the first data and the second data in the third register group as the input for both the configurable spiking neuronal computing unit and the coding module.

In an example of the present disclosure, the coding module includes a first coding module and a second coding module, the first coding module is configured to code the first data input externally or from the logic module, and the second coding module is configured to code the second data input externally or from the logic module.

In an example of the present disclosure, the decoding module includes a first decoding module and a second decoding module, the first decoding module is configured to decode the first data input externally or from the logic module in the error checking and correcting mode, and the second decoding module is configured to decode the second data input externally or from the logic module in the error checking and correcting mode.

In an example of the present disclosure, the coding mode of the coding module and the decoding mode of the decoding module codes/decodes an input data by different coding/decoding bits depending on different neuron models, for error checking and multiple-bit error correcting.

### Example 4

Provided is a spiking neuron reinforcing method, including

performing raw storage on one or both of a first data and a second data input externally;

coding one or both of the first data and the second data input externally;

storing a coded first data and a coded second data separately;

decoding one or both of the coded first data and the coded second data in an error checking and correcting (ECC) mode;

in response to fewer errors present during decoding, selecting an error-corrected data for configuring a spiking neuron; or

in response to more errors present during decoding, selecting one or both of the first data and the second data in the raw storage for configuring the spiking neuron and replacing an uncoded data corresponding to the error-checked data.

In an example of the present disclosure, the first data is configuration information, according to which the spiking neuron is configured to be a Leaky-Integrate-and-Fire (LIF) neuron, an Izhikevich neuron, or a Hodgkin-Huxley neuron.

In an example of the present disclosure, the second data is a model parameter, according to which the spiking neuron is configured to generate a corresponding exciting or inhibiting spiking signal by neuron firing.

In an example of the present disclosure, the raw storage is spatially isolated from coded data storage, or the raw storage is independently reinforced, for reducing a spatial single event effect.

In an example of the present disclosure, the raw storage is spatially isolated from the coded data storage in a criss-cross layout with a spatial isolation distance determined in accordance with spatial environment where the spiking neuron operates, and the spatial environment includes a space orbital altitude, a spatial irradiation environment, and a spatial isolation layout.

In an example of the present disclosure, the spiking neuron reinforcing method includes: coding one or both of the first data and the second data in an ECC mode; and decoding one or both of the coded first data and the coded second data in an ECC mode.

In an example of the present disclosure, the spiking neuron reinforcing method includes decoding an input data in the error checking and correcting mode, for error checking and 1-bit error correcting.

In an example of the present disclosure, the spiking neuron reinforcing method includes selecting one or both of the first data and the second data in the raw storage for configuring the spiking neuron in response to positive multiple-bit error checking during decoding.

In an example of the present disclosure, the coding mode of the coding module matches with the decoding mode of the decoding module; and an input data is coded/decoded by different coding/decoding bits depending on different neuron models, for error checking and multiple-bit error correcting.

In an example of the present disclosure, the spiking neuron reinforcing method includes: coding the first data by a first coding circuit; and coding the second data by a second coding circuit.

In an example of the present disclosure, the spiking neuron reinforcing method includes:

decoding the first data by a first decoding circuit in the error checking and correcting mode; and

decoding the second data by a second decoding circuit in the error checking and correcting mode.

The content not described in detail in the specification of the present disclosure belongs to the common knowledge of those skilled in the art.

Although the present disclosure has been disclosed as a preferred embodiment, it is not intended to limit the present disclosure. Any person skilled in the art may use the disclosed methods and technical content to make possible changes and modifications to the technical solution of the present disclosure without departing from the spirit and scope of the present disclosure. Therefore, any simple modifications, equivalent changes, or modifications made to the above embodiments based on the technical essence of the present disclosure that do not depart from the technical solution of the present disclosure are within the scope of protection of the technical solution of the present disclosure.

1. A spiking neuron reinforcing circuit, comprising
a coding module, configured to code one or both of a first data and a second data input externally or from a logic module;
a first register group, configured to store a coded first data;
a second register group, configured to store a coded second data;
a third register group, configured to directly store one or both of the first data and the second data;
a decoding module, configured to
decode one or both of the coded first data and the coded second data in an error checking and correcting (ECC) mode; and
recode a decoding result,
wherein a decoding mode of the decoding module corresponds to a coding mode of the coding module;
the logic module, configured to, based on the decoding result,
select one or both of a decoded first data and a decoded second data as an input for a configurable spiking neuronal computing unit, or
select one or both of the first data and the second data in the third register group as the input for both the configurable spiking neuronal computing unit and the coding module;
the configurable spiking neuronal computing unit, capable of being configured according to one or both of an input first data and an input second data.

2. The spiking neuron reinforcing circuit according to claim 1, wherein the first data is configuration information, and the second data is a model parameter.

3. The spiking neuron reinforcing circuit according to claim 2, wherein the configurable spiking neuronal computing unit is configured to be a Leaky-Integrate-and-Fire (LIF) neuron, an Izhikevich neuron, or a Hodgkin-Huxley neuron according to the configuration information.

4. The spiking neuron reinforcing circuit according to claim 2, wherein the configurable spiking neuronal computing unit is configured to generate a corresponding exciting or inhibiting spiking signal by neuron firing according to the model parameter.

5. The spiking neuron reinforcing circuit according to claim 1, wherein the third register group is spatially isolated from the first register group and the second register group, or the third register group is independently reinforced.

6. The spiking neuron reinforcing circuit according to claim 5, wherein
the third register group is spatially isolated from the first register group and the second register group in a criss-cross layout, and
a first spatial distance between the third register group and the first register group, as well as a second spatial distance between the third register group and the second register group, are determined in accordance with spatial environment where the configurable spiking neuronal computing unit operates, wherein the spatial environment comprises a space orbital altitude, a spatial irradiation environment, and a spatial layout for the first register group, the second register group and the third register group.

7. The spiking neuron reinforcing circuit according to claim 1, wherein the coding module is configured to code one or both of the first data and the second data in an ECC mode.

8. The spiking neuron reinforcing circuit according to claim 1, wherein the decoding module is configured to decode one or both of the coded first data and the coded second data in the error checking and correcting mode, for error checking and 1-bit error correcting.

9. The spiking neuron reinforcing circuit according to claim 1, wherein
in response to the decoding result of positive multiple-bit error checking, the logic module is configured to select the first data and the second data in the third register group as the input for both the configurable spiking neuronal computing unit and the coding module.

10. The spiking neuron reinforcing circuit according to claim 1, wherein
the coding module comprises a first coding module and a second coding module,
the first coding module is configured to code the first data input externally or from the logic module,
the second coding module is configured to code the second data input externally or from the logic module, and
wherein the decoding module comprises a first decoding module and a second decoding module,
the first decoding module is configured to decode the coded first data in the error checking and correcting mode. the second decoding module is configured to decode the coded second data in the error checking and correcting mode.

11. (canceled)

12. The spiking neuron reinforcing circuit according to claim 1, wherein
the coding mode of the coding module and the decoding mode of the decoding module codes/decodes an input data by different coding/decoding bits depending on different neuron models, for error checking and 1-to 4-bit error correcting.

13. A spiking neuron reinforcing method, comprising
coding, by a coding module, one or both of a first data and a second data input externally or from a logic module;
storing a coded first data by a first register group;
storing a coded second data by a second register group;
directly storing, by a third register group, one or both of the first data and the second data;
decoding, by a decoding module, one or both of the coded first data and the coded second data in an error checking and correcting (ECC) mode, wherein a decoding mode of the decoding module corresponds to a coding mode of the coding module;
recoding a decoding result by the decoding module;
selecting, by the logic module based on the decoding result,
one or both of a decoded first data and a decoded second data as an input for a configurable spiking neuronal computing unit, or
one or both of the first data and the second data in the third register group as the input for both the configurable spiking neuronal computing unit and the coding module.

14. The spiking neuron reinforcing method according to claim 13, wherein the first data is configuration information, according to which the spiking neuron the configurable spiking neuronal computing unit is configured to be a Leaky-Integrate-and-Fire (LIF) neuron, an Izhikevich neuron, or a Hodgkin-Huxley neuron, and
the second data is a model parameter, according to which the configurable spiking neuronal computing unit is configured to generate a corresponding exciting or inhibiting spiking signal by neuron firing.

15. (canceled)

16. The spiking neuron reinforcing method according to claim 13, wherein the third register group is spatially isolated from the first register group and the second register group, or the third register group is independently reinforced.

17. The spiking neuron reinforcing method according to claim 16, wherein the third register group is spatially isolated from the first register group and the second register group in a criss-cross layout, and
a first spatial distance between the third register group and the first register group, as well as a second spatial distance between the third register group and the second register group, are determined in accordance with spatial environment where the configurable spiking neuronal computing unit operates, wherein the spatial environment comprises a space orbital altitude, a spatial irradiation environment, and a spatial layout for the first register group, the second register group and the third register group.

18. The spiking neuron reinforcing method according to claim 13, comprising:
coding one or both of the first data and the second data in an ECC mode; and
decoding one or both of the coded first data and the coded second data in an ECC mode.

19. The spiking neuron reinforcing method according to claim 13, comprising
decoding one or both of the coded first data and the coded second data in the error checking and correcting mode, for error checking and 1-bit error correcting.

20. The spiking neuron reinforcing method according to claim 13, comprising
selecting, by the logic module, the first data and the second data in the third register group as the input for both the configurable spiking neuronal computing unit and the coding module in response to the decoding result of positive multiple-bit error checking.

21. The spiking neuron reinforcing method according to claim 13, wherein
the coding mode of the coding module matches with the decoding mode of the decoding module; and
an input data is coded/decoded by different coding/decoding bits depending on different neuron models, for error checking and 1-to 4-bit error correcting.

22. The spiking neuron reinforcing method according to claim 13, comprising:
coding the first data by a first coding circuit;
coding the second data by a second coding circuit
decoding the coded first data by a first decoding circuit in the error checking and correcting mode; and
decoding the coded second data by a second decoding circuit in the error checking and correcting mode.

23. (canceled)
